(19) United States
(12) Patent Application Publication
(10) Pub. No.: US 2011/0119746 A1
(43) Pub. Date: May 19, 2011

(54) Identity Verification Method and Network Device for Implementing the Same

(76) Inventor: Kai-Han Yang, Taipei City (TW)

(21) Appl. No.: 12/944,397

(22) Filed: Nov. 11, 2010

(30) Foreign Application Priority Data
Nov. 16, 2009 (TW) 098138806

(51) Int. Cl. H04L 9/32; G06F 21/00

(52) U.S. Cl. 726/7

(57) ABSTRACT

An identity verification method includes the steps of: i) in response to a login request from a user end, generating and providing a query to the user end; and ii) in response to an answer from the user end, verifying identity of the user end. The query includes indices of a verification table corresponding to the user end that are arranged in a random order in a ring formation, and requires the user end to provide an answer containing code contents of the table corresponding to a user-end selected set of adjacent ones of the indices in the ring formation. Identity of the user end is verified by determining whether the code contents in the answer are found in the table and whether the indices corresponding to the code contents in the answer are adjacent to each other with reference to the ring formation in the query.

### CROSS-REFERENCE TO RELATED APPLICATION

This application claims priority of Taiwanese Application No. 098138806, filed on Nov. 16, 2009.

### BACKGROUND OF THE INVENTION

1. Field of the Invention

The present invention relates to an identity verification method, more particularly to an identity verification method to be implemented using a network device for verifying identity of a user end.

2. Description of the Related Art

Generally, a conventional identity verification method utilizing simple passwords is a basic and commonly used method for verifying a user end. However, the passwords may be heedlessly leaked to other people by peeping, guessing, Trojan code, phishing, etc. since the passwords are simple.

To address the foregoing problem, several identity verification methods, such as public key infrastructure (PKI) and one-time password (OTP), have been proposed for further ensuring security and privacy of a network system and users thereof. Nevertheless, these identity verification methods still have drawbacks. First, the user end needs an additional electronic device, such as a card reader for an integrated circuit card, a password generator, etc., for identity verification. Therefore, these identity verification methods are relatively inconvenient for the user end, and it is difficult to popularize these methods. Further, some of these identity verification methods still have a security leak. For example, the OTP is unable to prevent the phishing.

### SUMMARY OF THE INVENTION

Therefore, an object of the present invention is to provide an identity verification method, which is relatively easy to use and provides relatively higher privacy and security, for verifying identity of a user end.

Accordingly, an identity verification method of the present invention is implemented using a network device for verifying identity of a user end. The identity verification method comprises the steps of:

a) configuring the network device to store a verification table corresponding to the user end, the verification table including a plurality of entries, each having an index and a corresponding code content;

b) in response to a login request from the user end, configuring the network device to generate a query for the user end and to provide the query to the user end, wherein the query includes the indices of the verification table corresponding to the user end that are arranged in a random order in a ring formation, and requires the user end to provide an answer containing the code contents corresponding to a user-end selected set of adjacent ones of the indices in the ring formation; and

c) in response to the answer provided by the user end, configuring the network device to verify identity of the user end by determining whether the code contents in the answer are found in the verification table corresponding to the user end and whether the indices corresponding to the code contents in the answer are adjacent to each other with reference to the ring formation of the indices included in the query provided to the user end.

Another object of the present invention is to provide a network device for implementing the identity verification method.

According to another aspect, a network device of this invention is adapted to verify identity of a user end.

The network device comprises an application program interface, a verification table management unit, and a verification unit.

The application program interface is operable to serve as a communication interface between the network device and the user end. The verification table management unit is configured to store a verification table corresponding to the user end. The verification table includes a plurality of entries, each having an index and a corresponding code content. In response to a login request received from the user end through the application program interface, the verification unit is operable to generate a query for the user end and provide the query to the user end through the application program interface. The query includes the indices of the verification table corresponding to the user end that are arranged in a random order in a ring formation, and requires the user end to provide an answer containing the code contents corresponding to a user-end selected set of adjacent ones of the indices in the ring formation. Further, in response to the answer provided by the user end through the application program interface, the verification unit is operable to verify identity of the user end by determining whether the code contents in the answer are found in the verification table corresponding to the user end, and whether the indices corresponding to the code contents in the answer are adjacent to each other with reference to the ring formation of the indices included in the query provided to the user end.

Preferably, the verification table management unit is further configured to randomly generate the verification table. Preferably for each of the entries of the verification table, the verification table management unit is configured to randomly select from a symbol group a symbol unit that corresponds to the code content of a corresponding one of the entries so as to generate the verification table.

Preferably, the symbol unit corresponding to each of the entries of the verification table includes two symbols, each randomly and independently selected from the symbol group.

Preferably, the symbol group includes alphanumeric characters.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram of a first preferred embodiment of a network device according to the present invention;

FIG. 2 illustrates the steps of an identity verification method implemented using the network device of the first preferred embodiment;

FIG. 3 illustrates an exemplary verification table corresponding to the first preferred embodiment;

FIG. 4 illustrates another exemplary verification table;

FIG. 5 illustrates contents of a verification table file used for managing the verification tables;

FIG. 6 illustrates indices in the verification table that are arranged in a random order in a ring formation;

FIG. 7 shows a query that is provided to the user end, that includes the ring-formation indices shown in FIG. 6, and that requires the user end to provide an answer; and

FIG. 8 is a block diagram of a second preferred embodiment of a network device according to the present invention.

### DETAILED DESCRIPTION OF THE PREFERRED EMBODIMENTS

Before the present invention is described in greater detail, it should be noted that like elements are denoted by the same reference numerals throughout the disclosure.

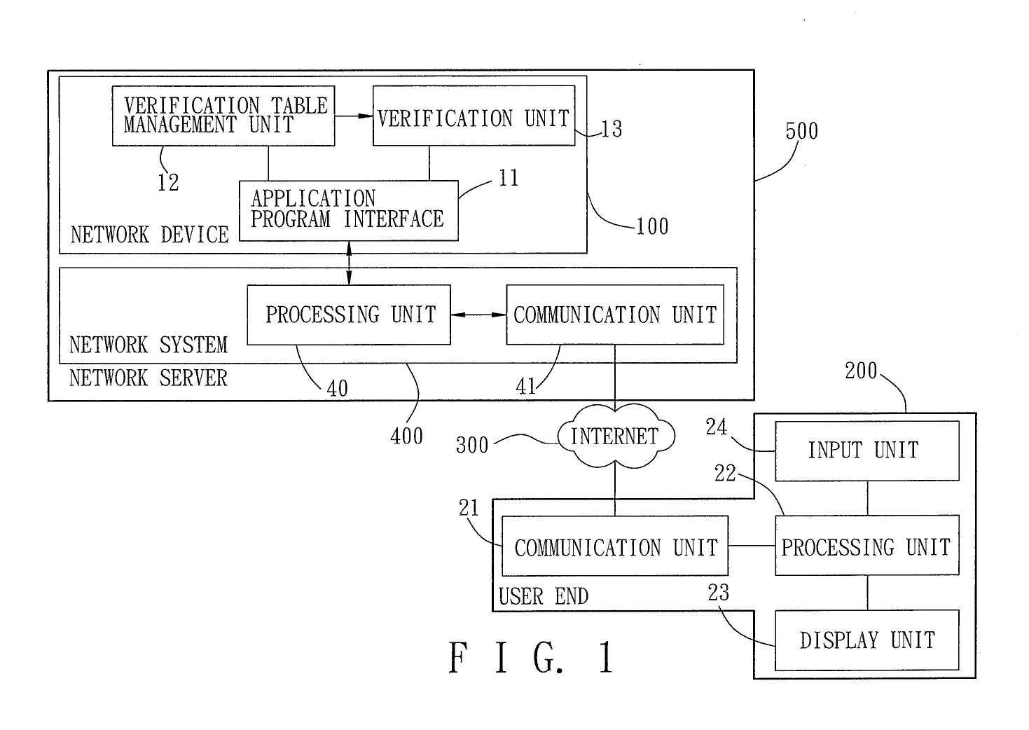

Referring to FIG. 1, the first preferred embodiment of a network device 500 of this invention is a network server operable to communicate with a user end 200 through a communication network, such as the Internet 300 in this embodiment. The network device 500 is operable to verify identity of the user end 200 in response to a login request from the user end 200, and allows the user end 200 to access or to make an online transaction after successfully verifying the identity of the user end 200. In this embodiment, the network device 500 includes a network system 400 coupled to the Internet 300, and a back-end identity verification device 100 coupled to the network system 400.

The network system 400 may be a device or system operable to provide information or service to the user end 200 through the Internet 300, such as a service provider, an information provider, a gaming platform, an online store, etc. The identity verification device 100 may be separate from or integrated with the network system 400. The user end 200 includes a communication unit 21, a processing unit 22, a display unit 12 and an input unit 24. Generally, the user end 200 is a personal computer, a notebook computer, or other known electronic devices capable of accessing the Internet 300, such as a personal digital assistant or a cell phone.

The identity verification device 100 includes an application program interface (API) 11, a verification table management unit 12, and a verification unit 13. In this embodiment, the API 11 may be implemented as a software module for communicating with the network system 400 so as to transmit information for verification therebetween. Accordingly, the API 11 is operable to control the network system 400 to generate an input/output interface that serves as a communication interface between the identity verification device 100 and the network system 400, and that allows a user of the user end 200 to input data or commands to the identity verification device 100.

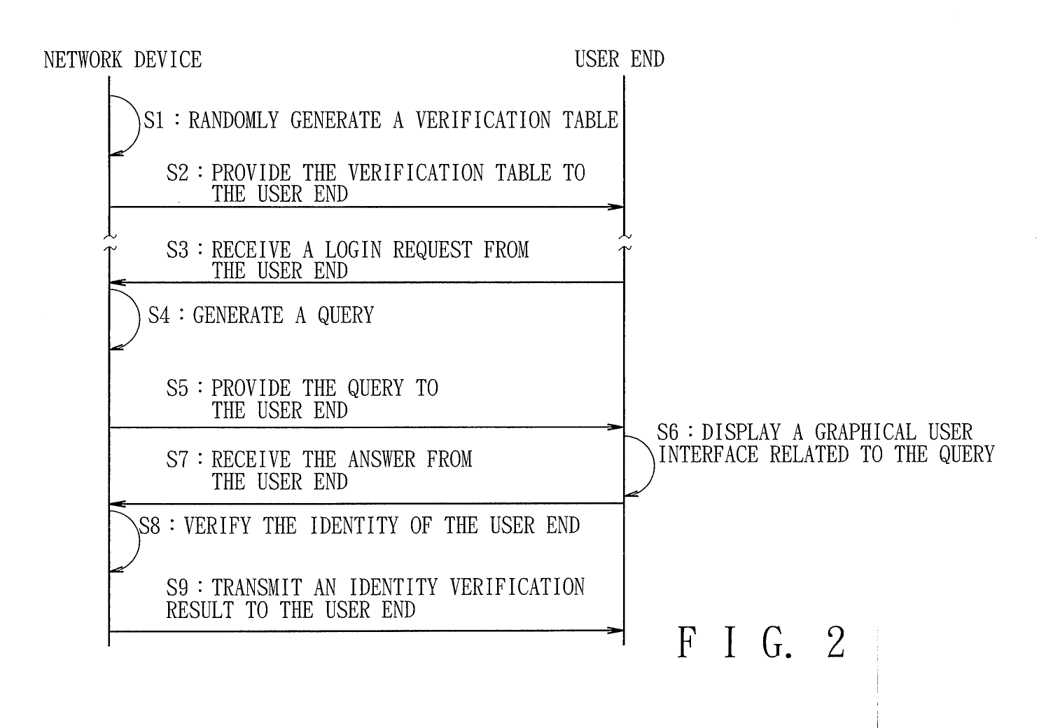

The network system 400 includes a processing unit 40 and a communication unit 41. The communication unit 41 is a network communication interface, and is operable to access the Internet 300 so as to communicate with the communication unit 21 of the user end 200. The processing unit 40 is coupled to the communication unit 41, and is operable to execute an application program provided by the API 11 so as to cooperate with the identity verification device 100 to perform an identity verification method for verifying identity of the user end 200. Details of the identity verification method will be described in the following with reference to FIG. 2.

In step S1, the verification table management unit 12 is operable to randomly generate a unique verification table for the user end 200. It should be noted that the verification table management unit 12 is operable to randomly generate a plurality of respective verification tables for other user ends. Each of the verification tables includes a number I×J of entries, each of which has an index and a corresponding code content.

For each of the verification tables, the verification table management unit 12 is operable to randomly select a number n (10<n≦I×J) of symbol units from a first symbol group, and the symbol units correspond to the code contents of first n ones of the entries, respectively. In this embodiment, each of the symbol units includes two symbols, each randomly and independently selected from the first symbol group. In other embodiments, each of the symbol units may include a single symbol randomly selected from the first symbol group. The index of each of the entries has a first index symbol i selected from a second symbol group, and a second index symbol j selected from a third symbol group. A number I of the first index symbols i respectively indicate a number of rows of the verification table, and a number J of the second index symbols j respectively indicate a number J of columns of the verification table. Thus, a number I×J of the indices correspond to the number I×J of the entries, respectively.

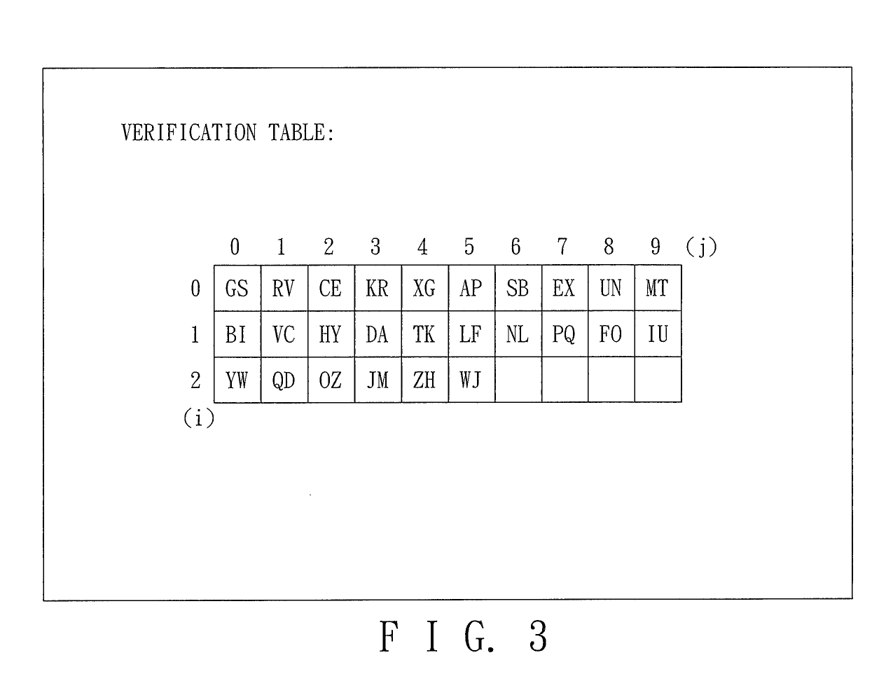

In practice, each of the first, second and third symbol groups may include alphanumeric characters, or other non-repeating serial symbols. In this embodiment, the first symbol group includes the capital letters A to Z, the second symbol group includes numerals 0 to 2 (i=0˜2, I=3), and the third symbol group includes numerals 0 to 9 (j=0˜9, J=10). Accordingly, referring to FIG. 3, each of the verification tables includes 30 entries, and the content of each of the first 26 of these entries corresponds to the symbol unit that includes two symbols, each randomly and independently selected from A to Z. The first and second index symbols i and j of the index of each of these 30 entries are selected from 0 to 2 and from 0 to 9 in a serial order, respectively.

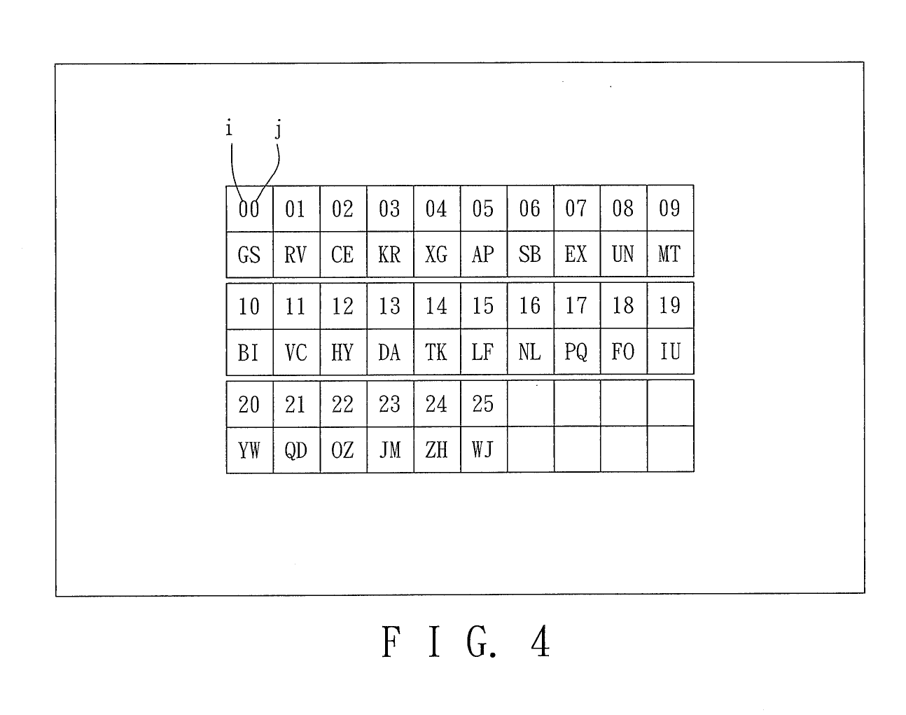

The verification table management unit 12 is operable to generate a mass number of the verification tables in advance. In response to an application for the verification table from the user end 200, the processing unit 40 of the network system 400 is operable to provide a unique one of the verification tables to the user end 200 in step S2. In other embodiments, a unique verification table may be generated immediately after receiving the application for the verification table from the user end 200. In this embodiment, a printed copy of the verification table shown in FIG. 3 is made as a card, and the verification table is coated with an opaque layer for protection against leakage of information. In response to the application for the verification table from the user end 200, the printed copy of the verification table is mailed to the user of the user end 200, or provided to the user end 200 in other ways. To view the verification table printed on the card, the user may scratch off the opaque layer on the card. Alternatively, the processing unit 40 of the network system 400 is operable to provide the verification table to the user end 200 in an electronic format with secure encryption through the communication unit 41. In other embodiments, the printed copy of the verification table may be made as another form shown in FIG. 4.

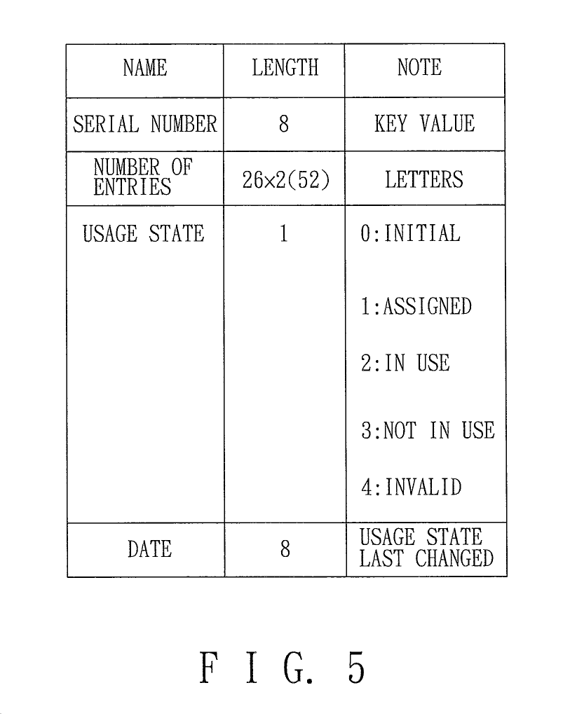

Further, the verification table management unit 12 is operable to store and manage the verification tables. Each of the verification tables stored in the verification table management unit 12 corresponds to a verification table file that contains, as shown in FIG. 5, a name, a unique serial number, a number of the entries of the verification table, a usage state, and a date on which the usage state of the verification table was last changed. In particular, when the verification table is not assigned to any user end 200, the usage state in the verification table file thereof is noted as “0” that indicates an initial state of the verification table. After the verification table is provided to the user end 200 in response to the application for the verification table, the usage state is changed as “1” indicating that this verification table has been assigned to the certain user end 200.

After receiving the verification table, the user end 200 needs to connect to the network system 400, and to register the verification table by providing the identity verification device 100 with the serial number corresponding to the verification table through the input/output interface provided by the API 11 of the identity verification device 100. Once the identity verification device 100 receives the serial number provided by the user end 200, the verification table management unit 12 is operable to change the usage state in the verification table file of the verification table corresponding to this serial number from “1” to “2” indicating that the verification table is in use. By such registration procedure, it can be ensured that the content of the verification table is not leaked before the user end 200 receives the verification table. If the content of the verification table has been leaked before the user end 200 receives the verification table (e.g., the opaque layer coated on the printed copy has been scratched off), the user end 200 may apply for cancellation of this verification table. Accordingly, the verification table management unit 12 is operable to note the usage state in the verification table file of the verification table as “4” indicating that this verification table is invalid.

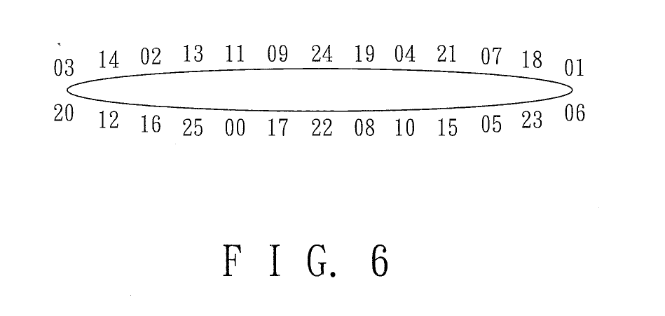

When the identity verification device 100 receives a login request from the user end 200 in step S3, the verification unit 13 of the identity verification device 100 is operable to generate a query for the user end 200 and to store the query in step S4 in response to the login request from the user end. The query includes at least a portion of the indices of the verification table corresponding to the user end 200 that are arranged in a random order in a ring formation, and a number (p) of the adjacent ones of the indices in the ring formation to be selected at the user end. Further, the query requires the user end to provide an answer containing the code contents corresponding to a user-end selected set of adjacent ones of the indices in the ring formation. The verification unit 13 is operable to randomly select k (k≦n) ones of the first n ones of the indices, and to randomly arrange the k ones of the indices in the ring formation to form the query. It can be appreciated that the answer to the query is relatively difficult to be cracked by other people when relatively more indices are selected in the ring formation. Therefore, in this embodiment, all of the first 26 of the indices (k=n=26) are used in the ring formation as shown in FIG. 6.

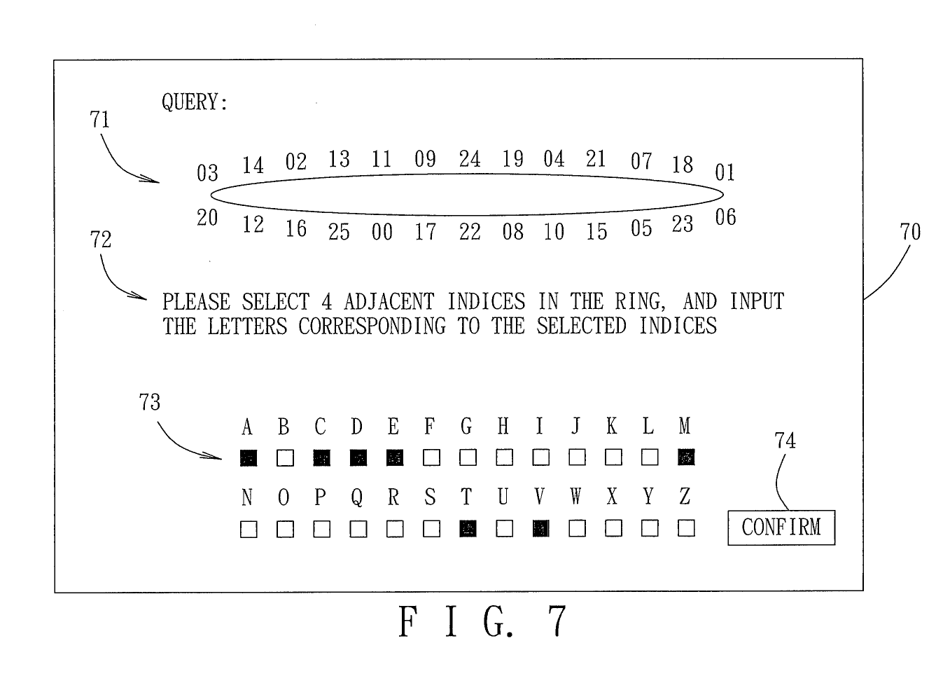

In step S5, the verification unit 13 of the identity verification device 100 is operable to provide the query generated in step S4 to the user end 200 through the API 11 and the communication unit 41 of the network system 400. When the user end 200 receives the query through the communication unit 21 thereof, the processing unit 22 is operable, instep S6, to control the display unit 23 to display a graphical user interface 70 related to the query as shown in FIG. 7. The graphical user interface 70 includes the selected indices in the ring formation 71, a statement 72 instructing that 4 (p=4) of the indices adjacent in the ring formation should be selected, and a virtual keypad 73 through which the answer is inputted at the user end 200. In this embodiment, the input unit 24 of the user end 200 is integrated with the display unit 23 as a touch screen, and is operable to cooperate with the virtual keypad 73 in the graphical user interface 70.

For example, the user of the user end 200 selects adjacent four of the indices “02”, “13”, “11” and “09” in the ring formation, and the answer should contain the code contents (CE, DA, VC and MT) corresponding to these four indices with reference to the verification table as shown in FIG. 3 or 4. Therefore, the user of the user end 200 inputs the answer “ACDEMTV” (one of the two repeated symbols C is omitted) using the virtual keypad 73 in the graphical user interface 70.

In other embodiments, the selection of the adjacent ones of the indices in the ring formation for the answer may be implemented automatically using an application program that is installed in the processing unit 22 of the user end 200 in advance. The processing unit 22 is operable to execute the application program to randomly select a predetermined number (p) of the adjacent ones of the indices in the ring formation, and to find the code contents corresponding to the selected ones of the indices with reference to an electronic format of the verification table stored in the user end 200 so as to generate the answer. Then, the processing unit 22 is operable to transmit the answer to the network system 400 automatically. Thus, human intervention is excused from the identity verification method so as to facilitate use of the identity verification method according to this invention.

In step S7, the answer “ACDEMTV” is transmitted to the network system 400 through the communication unit 21 of the user end 200 when a confirm button 74 of the virtual keypad 73 is pressed. Then, the network system 400 is operable to transmit the answer “ACDEMTV” to the verification unit 13 of the identity verification device 100 through the input/output interface and the API 11.

In this embodiment, since the answer transmitted to the network system 400 only contains a maximum of 8 letters, other people still have difficulty in analyzing the answer to derive the data in the verification table even if they have access to both the answer and the query. The probability of guessing the correct answer is only 1/97348 in this embodiment (26/(C₈²⁶+C₇²⁶+C₆²⁶+C₅²⁶+C₄²⁶)=1/97348). Since the probability of guessing the correct answer is considerably low, the identity verification method according to this invention is capable of providing sufficient security and privacy. The variables n, k and p that are related to the security may be varied in practice for different requirements.

In step S8, in response to the answer “ACDEMTV” provided by the user end 200, the verification unit 13 of the identity verification device 100 is operable to verify identity of the user end 200. In particular, the verification unit 13 is operable to find the indices in the verification table that correspond to the symbol unit in which a first one of the two letters is A, C, D, E, M, T or V. Accordingly, seven indices “05”, “02”, “13”, “07”, “09”, “14” and “11” are found. Then, the verification unit 13 is operable to find the indices in the verification table that correspond to the symbol unit in which a second one of the two letters is A, C, D, E, M, T or V. Thus, seven indices “13”, “11”, “21”, “02”, “23”, “09” and “01” are found. The verification unit 13 is further operable to take common ones of the indices thus found, i.e., “13”, “11”, “02” and “09”, and to determine whether these four indices are adjacent to each other with reference to the ring formation of the indices included in the query provided to the user end 200.

In step S9, the network system 400 is operable to transmit an identity verification result to the user end 200. When these four indices are adjacent to each other with reference to the ring formation of the indices included in the query, the identity verification for the user end 200 is successful and the identity verification device 100 allows the user end 200 to access the network system 400. Otherwise, the identity verification device 100 refuses the user end 200 to gain access to the network system 400.

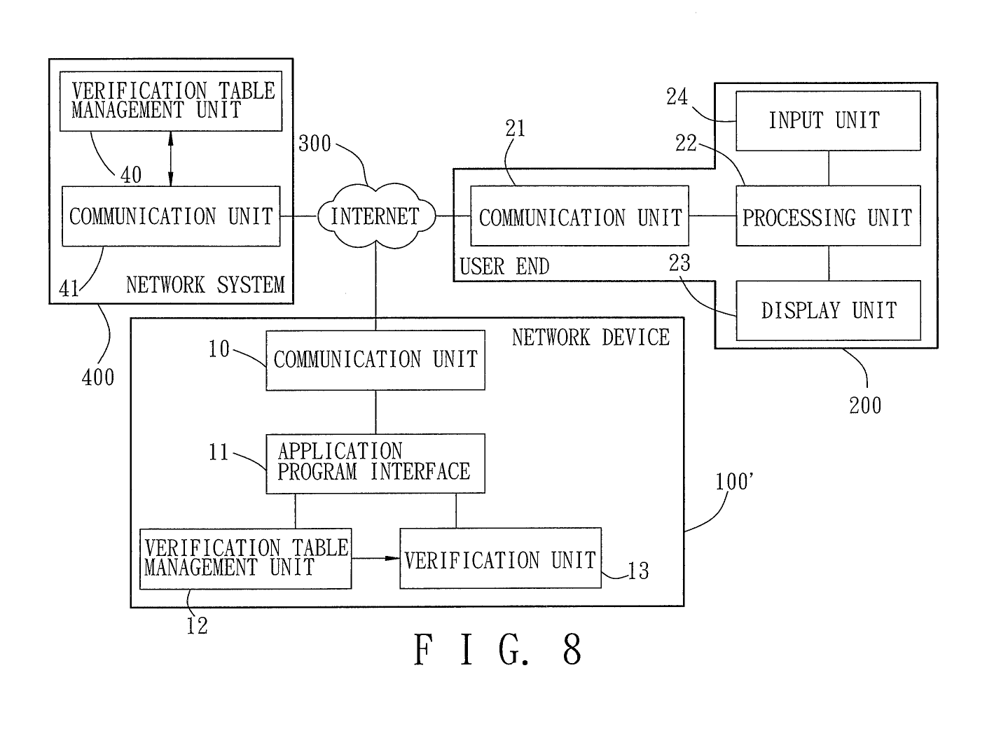

Referring to FIG. 8, the second preferred embodiment of a network device 100′ of this invention has a configuration similar to that of the identity verification device 100 of the first preferred embodiment. In the second preferred embodiment, the network device 100′ is separated from the network system 400, and further includes a communication unit 10 operable to independently access the Internet 300. Operations of the components of the network device 100′ in this embodiment are also similar to those of the first preferred embodiment. The network device 400 is configured to have a protocol with the network device 100′ in advance. Thus, in response to a login request from the user end 200 connected to the network system 400, the network system 400 is operable to send to the network device 100′ a request to verify the identity of the user end 200.

In conclusion, the verification table is provided to the user end 200 in advance, and the query is generated in response to the login request from the user end 200. The query includes the indices of the verification table corresponding to the user end that are arranged in a random order in the ring formation. Further, the query requires the user end 200 to select the number p of the indices that are adjacent in the ring formation, and provide the answer containing the code contents corresponding to a selected set of the adjacent ones of the indices in the ring formation. In response to the answer provided by the user end 200, the network device of this invention is operable to verify identity of the user end 200 by determining whether the code contents in the answer are found in the verification table corresponding to the user end 200, and whether the indices corresponding to the code contents in the answer are adjacent to each other with reference to the ring formation of the indices included in the query provided to the user end 200. The identity verification is successful when the determination is affirmative. Thus, the identity verification method according to the present invention is able to verify the identity of the user end 200 with a relatively high level of security and privacy.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An identity verification method to be implemented using a network device for verifying identity of a user end, said identity verification method comprising the steps of:
a) configuring the network device to store a verification table corresponding to the user end, the verification table including a plurality of entries, each having an index and a corresponding code content;
b) in response to a login request from the user end, configuring the network device to generate a query for the user end and to provide the query to the user end, wherein the query includes the indices of the verification table corresponding to the user end that are arranged in a random order in a ring formation, and requires the user end to provide an answer containing the code contents corresponding to a user-end selected set of adjacent ones of the indices in the ring formation; and
c) in response to the answer provided by the user end, configuring the network device to verify identity of the user end by determining whether the code contents in the answer are found in the verification table corresponding to the user end and whether the indices corresponding to the code contents in the answer are adjacent to each other with reference to the ring formation of the indices included in the query provided to the user end.

2. The identity verification method as claimed in claim 1, further comprising, prior to step a), the step of a0) configuring the network device to randomly generate the verification table.

3. The identity verification method as claimed in claim 2, wherein, in step a0), the code content of each of the entries of the verification table corresponds to a symbol unit randomly selected from a symbol group.

4. The identity verification method as claimed in claim 3, wherein, in step a0) the symbol unit corresponding to each of the entries of the verification table includes two symbols, each randomly and independently selected from the symbol group.

5. The identity verification method as claimed in claim 3, wherein, in step a0), the symbol group includes alphanumeric characters.

6. The identity verification method as claimed in claim 1, further comprising the step of configuring the network device to provide the verification table to the user end in an electronic format.

7. The identity verification method as claimed in claim 1, wherein a printed copy of the verification table is provided to the user end.

8. The identity verification method as claimed in claim 1, wherein, in step b), the query includes at least a portion of the indices of the verification table corresponding to the user end.

9. The identity verification method as claimed in claim 1, wherein, in step b), the query further includes a number of the adjacent ones of the indices in the ring formation to be selected at the user end.

10. The identity verification method as claimed in claim 1, wherein, in step b), the query is provided to the user end in a form of a graphical user interface that includes a virtual keypad through which the answer is inputted at the user end.

11. A network device for implementing an identity verification method for verifying identity of a user end, said network device comprising:
a communication unit operable to communicate with the user end; and
a processing unit coupled said communication unit, and operable to perform the identity verification method that includes the steps of:
a) storing a verification table corresponding to the user end, the verification table including a plurality of entries, each having an index and a corresponding code content,
b) in response to a login request received from the user end through said communication unit, generating a query for the user end and providing the query to the user end through said communication unit, wherein the query includes the indices of the verification table corresponding to the user end that are arranged in a random order in a ring formation, and requires the user end to provide an answer containing the code contents corresponding to a user-end selected set of adjacent ones of the indices in the ring formation, and
c) in response to the answer provided by and received from the user end through said communication unit, verifying identity of the user end by determining whether the code contents in the answer are found in the verification table corresponding to the user end and whether the indices corresponding to the code contents in the answer are adjacent to each other with reference to the ring formation of the indices included in the query provided to the user end.

12. The network device as claimed in claim 11, wherein the identity verification method further includes, prior to step a), the step of a0) randomly generating the verification table.

13. The network device as claimed in claim 12, wherein, in step a0), the code content of each of the entries of the verification table corresponds to a symbol unit randomly selected from a symbol group.

14. The network device as claimed in claim 13, wherein, in step a0), the symbol unit corresponding to each of the entries of the verification table includes two symbols, each randomly and independently selected from the symbol group.

15. The network device as claimed in claim 13, wherein, in step a0), the symbol group includes alphanumeric characters.

16. The network device as claimed in claim 11, wherein the identity verification method further includes the step of providing the verification table to the user end in an electronic format.

17. The network device as claimed in claim 11, wherein, in step b), the query includes at least a portion of the indices of the verification table corresponding to the user end.

18. The network device as claimed in claim 11, wherein, in step b), the query further includes a number of the adjacent ones of the indices in the ring formation to be selected at the user end.

19. The network device as claimed in claim 11, wherein, said processing unit is operable, in step b), to provide the query to the user end in a form of a graphical user interface that includes a virtual keypad through which the answer is inputted at the user end.

20. The network device claimed in claim 11, which is a network server.

21. A network device adapted to verify identity of a user end, said network device comprising:
an application program interface operable to serve as a communication interface between said network device and the user end;
a verification table management unit configured to store a verification table corresponding to the user end, the verification table including a plurality of entries, each having an index and a corresponding code content; and
a verification unit which, in response to a login request received from the user end through said application program interface, operates to
generate a query for the user end and provide the query to the user end through said application program unit, wherein the query includes the indices of the verification table corresponding to the user end that are arranged in a random order in a ring formation, and requires the user end to provide an answer containing the code contents corresponding to a user-end selected set of adjacent ones of the indices in the ring formation, and
in response to the answer provided by the user end through said application program interface, verify identity of the user end by determining whether the code contents in the answer are found in the verification table corresponding to the user end and whether the indices corresponding to the code contents in the answer are adjacent to each other with reference to the ring formation of the indices included in the query provided to the user end.

22. The network device as claimed in claim 21, wherein said verification table management unit is further configured to randomly generate the verification table.

23. The network device as claimed in claim 22, wherein, for each of the entries of the verification table, said verification table management unit is configured to randomly select from a symbol group a symbol unit that corresponds to the code content of a corresponding one of the entries so as to generate the verification table.

24. The network device as claimed in claim 23, wherein said verification table management unit is configured to randomly and independently select from the symbol group two symbols as the symbol unit for each of the entries of the verification table.

25. The network device as claimed in claim 23, wherein the symbol group includes alphanumeric characters.

26. The network device as claimed in claim 21, wherein said verification table management unit is further configured to provide the verification table to the user end in an electronic format.

27. The network device as claimed in claim 21, wherein said verification unit is operable to generate the query that includes at least a portion of the indices of the verification table corresponding to the user end.

28. The network device as claimed in claim 21, wherein said verification unit is operable to generate the query that further includes a number of the adjacent ones of the indices in the ring formation to be selected at the user end.

29. The network device as claimed in claim 21, wherein said verification unit is operable to provide the query to the user end in a form of a graphical user interface that includes a virtual keypad through which the answer is inputted at the user end.
